(19) United States
(12) Patent Application Publication
(10) Pub. No.: US 2010/0073833 A1
(43) Pub. Date: Mar. 25, 2010

(54) CIRCUIT APPARATUS HAVING ELECTROSTATIC DISCHARGE PROTECTION FUNCTION

(76) Inventors: Hao-Ping Hong, Hsinchu County (TW); Yen-Hsun Hsu, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/235,613

(22) Filed: Sep. 23, 2008

(51) Int. Cl. H02H 9/00

(52) U.S. Cl. 361/56

(57) ABSTRACT

A circuit apparatus having an electrostatic discharge (ESD) protection function includes a first circuit module, a second circuit module, and a thick-oxide transistor. The first circuit module operates in a first power supply domain and includes at least a first transistor. The second circuit module operates in a second power supply domain different from the first power supply domain and includes at least a second transistor. The thick-oxide transistor has a control terminal for receiving a control signal, a first terminal coupled to the first circuit module, and a second terminal coupled to the second circuit module, and the thick-oxide transistor is utilized for selectively performing an ESD protection operation according to the control signal.

### BACKGROUND OF THE INVENTION

1. Field of the Invention

The present invention relates to a circuit apparatus, and more particularly, to a circuit apparatus having an electrostatic discharge (ESD) protection function.

2. Description of the Prior Art

Please refer to FIG. 1. FIG. 1 shows a simplified diagram of a conventional circuit apparatus 100. The conventional circuit apparatus 100 includes a first circuit module 110 and a second circuit module 120 operating in two different power supply domains, respectively. The first circuit module 110 includes a thin-oxide PMOS transistor 112 and a thin-oxide NMOS transistor 114. The second circuit module 120 includes a thin-oxide PMOS transistor 122 and a thin-oxide NMOS transistor 124. Since the first circuit module 110 and the second circuit module 120 respectively operate in two different power supply domains, when an ESD event occurs from VDD2 to VSS1, the thin-oxide PMOS transistor 122 will fail easily due to the ESD event.

### SUMMARY OF THE INVENTION

It is therefore one of the objectives of the present invention to provide a circuit apparatus having an electrostatic discharge (ESD) protection function in order to solve the above problem.

According to an embodiment of the present invention, a circuit apparatus having an ESD protection function is disclosed. The circuit apparatus includes a first circuit module, a second circuit module, and a thick-oxide transistor. The first circuit module operates in a first power supply domain and includes at least a first transistor. The second circuit module operates in a second power supply domain different from the first power supply domain and includes at least a second transistor. The thick-oxide transistor has a control terminal for receiving a control signal, a first terminal coupled to the first circuit module, and a second terminal coupled to the second circuit module, and the thick-oxide transistor is utilized for selectively performing an ESD protection operation according to the control signal. At least one of the first transistor and the second transistor is a thin-oxide transistor. The thick-oxide transistor is turned off by the control signal when an ESD event occurs, and the thick-oxide transistor is turned on by the control signal when the circuit apparatus is in normal operation mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified diagram of a conventional circuit apparatus.

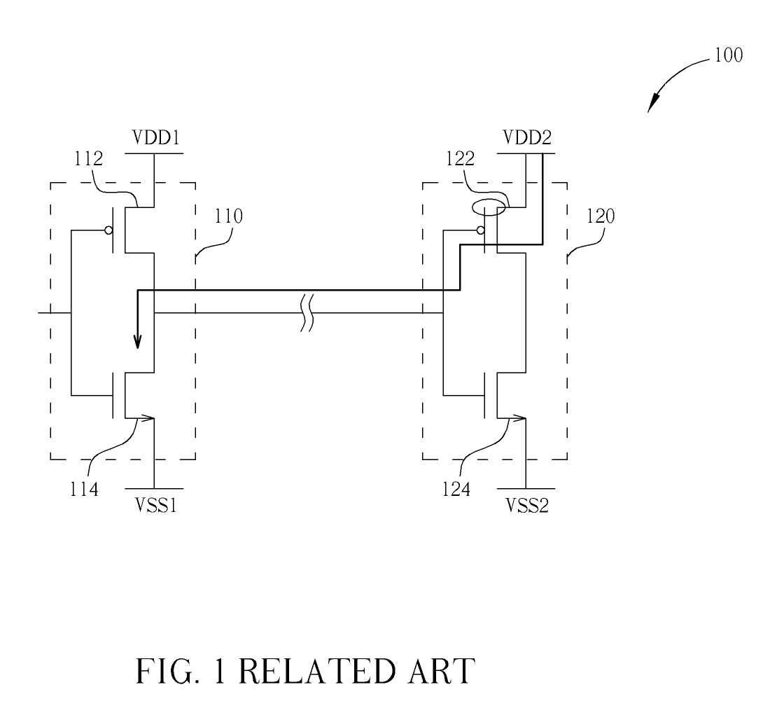

FIG. 2 shows a simplified diagram of a circuit apparatus having an electrostatic discharge (ESD) protection function in accordance with an embodiment of the present invention.

FIG. 3 shows a first embodiment of the control unit in the circuit apparatus in FIG. 2 in accordance with the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

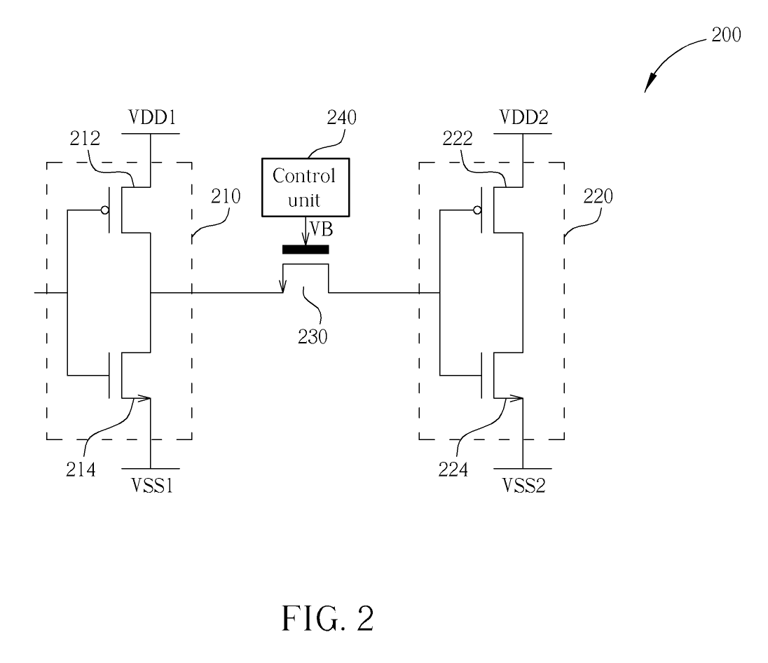

Please refer to FIG. 2. FIG. 2 shows a simplified diagram of a circuit apparatus 200 having an electrostatic discharge (ESD) protection function in accordance with an embodiment of the present invention. As shown in FIG. 2, the circuit apparatus 200 includes a first circuit module 210, a second circuit module 220, a thick-oxide NMOS transistor 230, and a control unit 240. The first circuit module 210 operates in a first power supply domain and is a core circuit of an electronic device. For illustrative clarity, the first circuit module 210 includes a thin-oxide PMOS transistor 112 and a thin-oxide NMOS transistor 114 in this embodiment. The second circuit module 220 operates in a second power supply domain different from the first power supply domain and is also a core circuit of the electronic device. For illustrative clarity, the first circuit module 210 includes a thin-oxide PMOS transistor 122 and a thin-oxide NMOS transistor 124 in this embodiment. VDD1 and VDD2 are not limited to be different voltage levels, but are low voltages (e.g. 1.2V) in general cases. VSS1 and VSS2 are not limited to be different voltage levels.

The thick-oxide NMOS transistor 230 has a control terminal (i.e. gate terminal), a first terminal coupled to the first circuit module 210, and a second terminal coupled to the second circuit module 220. The control unit 240 is coupled to the gate terminal of the thick-oxide NMOS transistor 230, and is for sensing whether an ESD event occurs to generate a control signal VB to turn off or turn on the thick-oxide NMOS transistor 230. In other words, the thick-oxide NMOS transistor 230 is utilized for selectively performing an ESD protection operation according to the control signal VB.

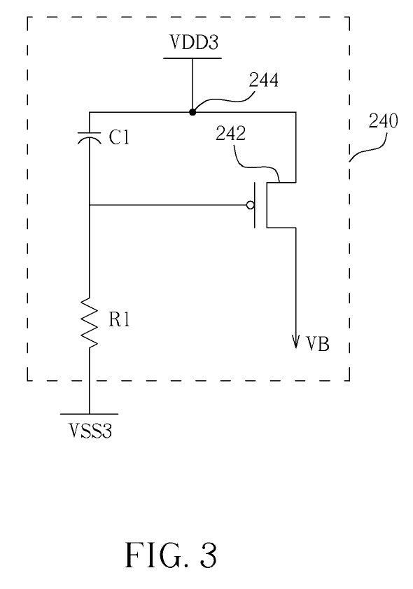

In a first embodiment of the present invention, the control unit 240 can be a bias voltage generating circuit including a PMOS transistor 242, a capacitor C1, and a resistor R1, as shown in FIG. 3. When an ESD event occurs, an instant discharging current may pull up the voltage level at node 244 from 0V (because at this time the circuit apparatus 200 is not enabled, the power supply of VDD3 is off). When the voltage level at node 244 is raised, due to the property of the capacitor C1, the gate voltage of the PMOS transistor 242 will be pulled up correspondingly. The PMOS transistor 242 will not be turned on, and the control signal VB will be low. As a result, the thick-oxide NMOS transistor 230 will be off, and the coupling path between the first circuit module 210 and the circuit module 220 will be cut off. The ESD protection between the first circuit module 210 and the circuit module 220 is thereby achieved. When the circuit apparatus 200 is enabled (i.e. the power is normally supplied to the node 244), VDD3 is provided to the gate terminal of the thick-oxide NMOS transistor 230 through the PMOS transistor 242. The thick-oxide NMOS transistor 230 is turned on to let the circuit apparatus 200 return to the normal state. In one embodiment, VDD3 is designed to have a high voltage level to reduce the turn-on impedance of the thick-oxide NMOS transistor 230; for example, VDD3 can be 2.5V.

In a second embodiment of the present invention, the control unit 240 can be a charge pump coupled to a power supply. When an ESD event is detected, the charge pump does no action. The control signal VB will be low, and thus the thick-oxide NMOS transistor 230 will be turned off to perform the ESD protection operation between the first circuit module 210 and the second circuit module 220. When the circuit apparatus 200 is enabled (no ESD event occurs), the control signal VB will be high due to the charge pump pulling up the power supplyvoltage, and thus the thick-oxide NMOS transistor 230 will be turned on to let the circuit apparatus 200 return to the normal state. In this embodiment, the voltage level provided by the power supply that the charge pump is coupled to is not limited since the charge pump can pull it up to the desired voltage level.

Please note that the above embodiments are only for illustrative purposes and are not meant to be limitations of the present invention. The most important feature of the technical content disclosed by the present invention is the insertion of a thick-oxide transistor in the interface between different power supply domains to selectively perform an ESD protection operation. The thick-oxide transistor should be turned off to block the path between two power supply domains under ESD test, and should be turned on under normal situation. Because the thick-oxide device is much stronger than thin-oxide device and can endure high voltage, it is suitable for ESD protection implementation. A person of average skill in the pertinent art should be able to easily understand that various modifications and alterations of the circuit apparatus should fall into the disclosed scope of the present invention provided that the ESD protection function with a thick-oxide transistor in the interface between different power supply domains is present.

Briefly summarized, the circuit apparatus having the ESD protection function disclosed by the present invention is clearly capable of avoiding the ESD problems associated with the prior art, as well as maintaining a low cost and small chip area.

Those skilled in the art will readily observe that numerous modifications and alterations of the device and method may be made while retaining the teachings of the invention.

What is claimed is:

1. A circuit apparatus having electrostatic discharge (ESD) protection function, comprising:
a first circuit module, operating in a first power supply domain, comprising at least a first transistor;
a second circuit module, operating in a second power supply domain different from the first power supply domain, comprising at least a second transistor; and
a thick-oxide transistor, having a control terminal for receiving a control signal, a first terminal coupled to the first circuit module, and a second terminal coupled to the second circuit module, for selectively performing an ESD protection operation according to the control signal;
wherein at least one of the first transistor and the second transistor is a thin-oxide transistor, the thick-oxide transistor is turned off by the control signal when an ESD event occurs, and the thick-oxide transistor is turned on by the control signal when the circuit apparatus is under normal operation.

2. The circuit apparatus of claim 1, further comprising:
a control unit, coupled to the control terminal of the thick-oxide transistor, for sensing whether the ESD event occurs to generate the control signal to turn off or turn on the thick-oxide transistor.

3. The circuit apparatus of claim 2, wherein the control unit is a bias voltage generating circuit.

4. The circuit apparatus of claim 2, wherein the control unit is a charge pump.

5. The circuit apparatus of claim 1, wherein the first transistor and the second transistor are both thin-oxide transistors.

6. The circuit apparatus of claim 1, wherein the control signal provides a specific voltage level which is higher than voltage levels of the first and second power supply domains to the control terminal of the thick-oxide transistor under normal operation.
